(19) United States
(12) Patent Application Publication
(10) Pub. No.: US 2024/0162716 A1
(43) Pub. Date: May 16, 2024

(54) MEANS AND METHOD FOR CONTROLLING DEVICES IN A MICROGRID

(71) Applicant: Enapter S.r.l., Crespina Lorenzana (IT)

(72) Inventors: Nikolay Viktorovitch KRASKO, Crespina Lorenzana (IT); Nikita Vladimirovitch AFANASENKO, Crespina Lorenzana (IT); Dmitriy Aleksandrovitch SHILIN, Crespina Lorenzana (IT)

(21) Appl. No.: 18/550,818

(22) PCT Filed: Mar. 15, 2022
(86) PCT No.: PCT/EP2022/056703

§ 371 Date: Sep. 15, 2023

(30) Foreign Application Priority Data
Mar. 15, 2021 (GB) 2103560.5

(51) Int. Cl. H02J 3/46; H02J 3/28; H02J 3/38; H02J 13/00

(52) U.S. Cl. CPC H02J 3/46; H02J 3/28; H02J 3/381; H02J 13/00002; H02J 13/00026; H02J 13/00028

(57) ABSTRACT

A microgrid comprising: a plurality of devices including at least: one or more primary devices, and one or more auxiliary devices, the plurality of devices being configured to form an at least partially connected mesh network for wireless communication of information between the devices, wherein at least one of the one or more auxiliary devices is controlled in dependence on communicated information relating to the operation of at least one of the one or more primary devices.

### FIELD OF INVENTION

The present invention relates to an improved means and method for facilitating communication and control of a plurality of devices in a microgrid, such as but not necessarily limited to controlling one or more electrolysers coupled to one or more dryers and/or water tanks.

### BACKGROUND

Microgrids are known, utilising one or more power sources such as PV panels, energy storage in the form of battery banks and loads, such as household appliances or industry. Microgrids incorporating hydrogen are becoming more prevalent due to the improved ability for longer term seasonal storage. Such microgrids include electrolysers, hydrogen storage and fuel cells. Auxiliary components such as compressors and dryers are often also used to allow for more efficient storage of hydrogen as a means of energy storage or for industrial use.

Hydrogen is seen as a key factor in decarbonisation of energy, especially with the advent of Green Hydrogen, generated in electrolysers using renewable energy. The hydrogen can be used for long term energy storage, industrial process or even in heating or adapted combustion engines, supplementing and supporting the push to electrification.

It is common for there to be wired connections between devices. Whilst this may work in more secure locations, in nature or outdoors this leaves wires vulnerable to interference, such as being chewed by mice.

Not all microgrids are sited in a single location. There is a need for microgrids which are easier to install, cheaper and easier to maintain, resilient to rodent (and other environmental) interference, and enabling a distanced or distributed infrastructure. Such a microgrid could serve a village or town instead of a single property, for example.

At present, devices such as gateways or programmable logic controllers (PLCs), are required to control such grids. Whilst functional, there is a need for a wireless alternative which is, not only easier to install, but also cheaper, and which has less ecological and environmental impact.

An object of an aspect of the present invention is to provide an improved means and method for facilitating communication and control of a plurality of devices in a microgrid, such as (but not necessarily limited to) controlling one or more dryers based on the operational state of one or more electrolysers coupled thereto.

### SUMMARY OF THE INVENTION

According to one aspect disclosed herein, there is provided a microgrid comprising: a plurality of devices including at least: one or more primary devices, wherein said primary devices are leading devices, and one or more auxiliary devices, wherein said auxiliary devices are following devices, wherein: the plurality of devices is configured to form at least a partially connected mesh network for wirelessly communicating information between the devices; and at least one of the one or more auxiliary devices is controlled in dependence on communicated information relating to the operation of at least one of the one or more primary devices. Preferably, each device comprises means for wirelessly transmitting and receiving data/information, such as a known wireless transceiver.

Therefore, the microgrid enables control of the auxiliary devices without the need for an external hardware or software controller, gateway, or PLC. This provides for a more flexible and efficient installation of the microgrid. The microgrid also enables communication between the devices, particularly communication of information relating to the operation of the primary device(s) to the auxiliary device(s) such that the auxiliary devices can operate in dependence on the operation of the primary device. This provides for more efficient control of the auxiliary devices. For example, the auxiliary device may be activated only when the primary device is activated, thereby preventing unnecessary activation of the auxiliary devices. Similarly, the power of the auxiliary device may be adjusted in dependence on the operation of the primary device, such that the auxiliary device does not use more power than is necessary based on the operation of the primary device.

Preferably, the primary device is an electrochemical device, more preferably an electrolyser, yet more preferably an AEM (anion exchange membrane) electrolyser, yet more preferably still an AEM electrolyser with a dry cathode.

Preferably, the one or more auxiliary devices are balance of plant facilities for the primary device, preferably wherein one auxiliary device provides a balance of plant facility for multiple primary devices. The term “balance of plant device” or “balance of plant facility” is used to refer to a device which supports the operation of the primary device, such as by supplying a substance to the primary device for use by it, or for processing a substance output from the primary device. Examples of such devices are water tanks for supplying water to an electrolyser (i.e., an exemplary primary device), or dryers or compressors for processing a gas stream output from the electrolyser.

Preferably, each of the one or more primary devices is physically connected to at least one of the one or more auxiliary devices, preferably wherein one auxiliary device is physically connected to multiple primary devices. More preferably, the physical connection facilitates a transfer of fluid (such as liquid water, water vapour, or hydrogen or oxygen gas) between the devices. Alternatively, the physical connection may facilitate a transfer of electricity between the device, such as when one of the devices is a renewable power source for supplying electricity to an electrolyser or a hydrogen fuel cell for generating electricity.

Preferably, the balance of plant facility is at least one of:
a water tank for supplying water to the primary device via the physical connection (in which case, a supply rate of water from the water tank may be controlled in dependence on communicated information relating to the water demand of at least one of the one or more primary devices);
a dryer for drying a gas stream, preferably a hydrogen gas steam, received from the primary device via the physical connection (in which case, a power level/drying rate of the dryer may be controlled in dependence on communicated information relating to the flow rate or pressure of a fluid output (e.g. a hydrogen gas output) from at least one of the one or more primary devices to the dryer); and/or
a compressor for compressing a gas stream, preferably a hydrogen gas steam, received from the primary device via the physical connection (in which case, a power level/compressing rate of the compressor may be controlled in dependence on communicated information relating to the flow rate or pressure of a fluid output (e.g. a hydrogen gas output) from at least one of the one or more primary devices to the compressor).

Preferably, the control of the auxiliary device comprises: activating, deactivating, or restarting the auxiliary device in dependence on the communicated information relating to the operation of at least one of the one or more primary devices. In this way, the auxiliary devices are operated more efficiently by activating the auxiliary devices only when the primary device(s) are activated.

Preferably, the control of the auxiliary device comprises setting a process setpoint for a process carried out by the auxiliary device and/or controlling a power level of the auxiliary device in dependence on the communicated information relating to the operation of at least one of the one or more primary devices.

Preferably, wherein the information relating to the operation of at least one of the one or more primary devices comprises a measurement of a parameter of a process carried out by the primary device, preferably wherein the measurement is taken by a sensor of the primary device. For example, the primary device may be provided with flow rate sensors, pressure sensors, temperature sensors, etc. for monitoring parameters of the operation of the primary device. These parameters may be communicated through the mesh network to the auxiliary device(s), and the operation of the auxiliary devices may be adjusted based on this communicated information.

Preferably, wherein the information relating to the operation of at least one of the one or more primary devices comprises:
a pressure, preferably relating to the pressure of fluid output (e.g. a hydrogen gas output) from the primary device;
a temperature, preferably relating to the temperature of an electrolyte when the primary device is an electrolyser;
a flowrate, preferably relating to the pressure of fluid input (e.g. a liquid water input) to or output from the primary device;
an active status indicative of whether the primary device is active or inactive;
a voltage,
an amperage,
an energy demand of the primary device,
a water level,
a water conductivity,
errors, and
a cumulative run time or cumulative inactive time of the primary device.

Preferably, the microgrid comprise one or more tertiary devices, wherein the operation of at least one of the one or more tertiary devices is controlled in dependence on communicated information relating to the operation of at least one of the one or more auxiliary devices. Thus, the devices of the microgrid may form a hierarchical chain, having a primary, auxiliary, and tertiary device, wherein at least one of the one or more auxiliary devices is controlled in dependence on communicated information relating to the operation of at least one of the one or more primary devices, and wherein at least one of the one or more tertiary devices is controlled in dependence on communicated information relating to the operation of at least one of the one or more auxiliary devices.

An example of this arrangement is a microgrid comprising a mesh network of at least one renewable power source, at least one electrolyser, and at least one dryer. The renewable power source acts as the primary device, the electrolyser acts as the auxiliary device, and the dryer acts as the tertiary device. The electrolyser may be activated only when the renewable power source is providing a sufficient power output (e.g. for a solar power source, the electrolyser may be activated only during daylight hours), thus the auxiliary devices (electrolyser) is controlled (activated) in dependence on information (e.g. a voltage or amperage) relating to the operation of the primary device (the renewable power source). The dryer may then be activated only when the electrolyser is producing a sufficient hydrogen output, thus the tertiary device (dryer) is controlled (activated) in dependence on information (e.g. a flow rate or output pressure) relating to the operation of the auxiliary device (the electrolyser).

The information relating to the operation of at least one of the one or more auxiliary devices may be the same as is listed above in respect of the primary devices. Similarly, the control of the tertiary device may be the same as is listed above in respect of the auxiliary devices (e.g. activating, deactivating, restarting, or setting a process setpoint).

Preferably, the at least partially connected mesh network is a fully connected mesh network. In this way, every device can communicate with every other device directly or indirectly through the network.

Preferably, the mesh network is further connected to a database for the recording of the communicated information. In this way, every device can communicate with every other device directly through the network.

Preferably, the mesh network is connected to the internet.

Preferably, shortest path bridging is used for communication between the primary and auxiliary devices.

Preferably, one or more of the primary and auxiliary devices is connected to a central computing/control means.

Preferably, each device comprises a communication module for communicating information between the devices.

Preferably, the primary and auxiliary devices communicate via any one or more of
Bluetooth®
Wi-Fi, and
Radio

Preferably, a user can remotely monitor communicated information from a separate computing device.

Preferably, each device has a unique identifier code.

According to another aspect disclosed herein, there is provided a method for controlling devices in a microgrid, the microgrid comprising a plurality of devices including at least: one or more primary devices, wherein said primary devices are leading devices; and one or more auxiliary devices, wherein said auxiliary devices are following devices, the method comprising:
connecting the plurality of devices to form an at least partially connected mesh network for wirelessly communicating information between the devices, and
controlling at least one of the one or more auxiliary devices in dependence on communicated information relating to the operation of at least one of the one or more primary devices.

As used herein the term “mesh network”, or “meshwork”, is used to mean a local network topology in which devices are connectable directly, dynamically and/or non-hierarchically to other devices and cooperate with one another to route data through the network. The connected devices form nodes in the mesh network. The mesh network may also comprise other nodes in addition to the connected devices, such infrastructure nodes. This lack of dependency on one node allows for every node to participate in the relay of information if required.

As used herein, the terms “primary device” and “leading device” may be used interchangeably.

As used herein, the terms “auxiliary device” and “following device” may be used interchangeably.

In a preferred embodiment, primary/leading devices are physically coupled to at least one auxiliary/following device, more preferably wherein the physical coupling involves a transfer of a fluid (such as liquid water, water vapour, or hydrogen or oxygen gas) between the devices. Preferably, the primary/leading devices are electrochemical devices such as electrolysers and the auxiliary/following devices are balance of plant (BOP) devices, such as dryers and/or water tanks. The dryers are preferably physically connected to an outlet of each electrolyser for the receiving and drying of a gas stream (e.g. hydrogen) produced by the electrolyser prior to storage and/or use. The water tanks are preferably physically connected to an inlet of each electrolyser to provide a supply of water to the electrolyser for use in an electrochemical process in the electrolyser. It is further envisaged that multiple primary devices may share a single auxiliary device.

An intention of the present invention is to provide means that would ensure that the auxiliary device, such as a dryer, or water tank, would be automatically activated upon start-up of the physically coupled primary device (e.g. electrolyser).

It is envisaged that a single microgrid may comprise either a single mesh network, or multiple mesh networks, the number of mesh networks being determined by the shared auxiliary devices.

It is envisaged that the data transmitted and/or received by the primary and/or auxiliary devices may include any one or more of: pressure, temperature, flowrate, on/off status, voltage, amperage, energy demand, errors, and cumulative runtime of the device, water level, water conductivity. Each of these parameters may be checked against a pre-determined set point wherein said set point may be amended in use by the user.

In an embodiment of the present invention, it is envisaged that the microgrid comprises an at least partially connected mesh network adapted to be connected by router or equivalent device to a wireless communications network such as the internet/cloud. The mesh network can also work in an isolated “island” (i.e. local) mode with no internet connection.

In an embodiment of the present invention, it is envisaged that the microgrid comprises an at least partially connected mesh network adapted to be connected to a database for the logging and optional analysis of performance data.

Whilst it is envisaged that a partially connected mesh network is sufficient, it is more beneficial that a fully connected mesh network is formed between the leading and following devices.

Alternatively, to ensure maximum functionality in embodiments reliant upon a partially connected mesh network, it is envisaged that algorithms may be employed such as shortest path bridging, to ensure all devices can communicate with each other, via other devices in the mesh network if necessary.

In embodiments where the leading device is an electrolyser, preferably it is an AEM electrolyser. More preferably still it is an AEM electrolyser operating with a dry cathode.

In a preferred embodiment the leading and following devices may be adapted to communicate via the mesh network with a central computing means/control means. It is also envisaged that additional types of leading and following devices may be present. For example, a renewable power source may be a leading device, whereas a compressor being dependent upon the output from the electrolysers may constitute a following device.

It is envisaged that each device is provided with a communication module, said communication module adapted to facilitate the transmission and receipt of wirelessly transmitted data.

Whilst it is envisaged that any wireless frequency, or frequency band may be used, restrictions on use exist for specific purposes. In a preferred embodiment, therefore, the devices may be adapted to communicate via Bluetooth® or Wi-Fi. Longer ranges may be covered using radio frequencies. For certain embodiments, larger antenna may be required as well as amplifiers and/or high pass filters, or other known components to ensure clear transmission and receipt of data. The present invention is not necessarily intended to be limited by such features.

In a preferred embodiment, the microgrid comprises a mesh network that is further adapted to be connected to the internet allowing a user to remotely monitor the status of each device within the network. Said remote monitoring being facilitated by a secure connection from a computing device such as a laptop, PC, tablet, or mobile phone. Alternatively, the user can check the status of the mesh network using local web interface running, for example, on one of the communication modules.

In a preferred embodiment it is envisaged an application may be provided for use on the computing means, with said application being adapted to allow automated configuration of identification of leading and following devices.

Means for ensuring a secure connection are known, and not subject to the present invention, so not discussed further.

For the purposes of monitoring and communication, it may be beneficial for each device to be provided with a unique identifier code. This may be provided at the time of manufacture or installation, or selected/input by the user.

The present invention has the benefit of removing the need for an external hardware or software controller, gateway, or PLC, a distinct benefit over the prior art of controlling microgrids, as more efficient control and flexible and efficient installation and utility are just some of the advantages afforded by the invention. Additionally, a single web interface for a leading device (e.g. electrolyser) can be used to manage the entire mesh network, as well as just a single connection to a leading device (e.g. electrolyser) such as via Modbus.

In a preferred embodiment, the meshwork operates on the basis of IEEE 802.11a/b/g/n standard at 2.4 GHz. It is envisaged that at least two devices would be present, preferably at least one leading device and at least one following device, such as one electrolyser and one dryer. More preferably, it is envisaged that a single following device (e.g. dryer) may service a plurality of leading devices (e.g. electrolysers). For example, there may be two or more electrolysers serviced by a single dryer for the purpose of removing water or other contaminants from the generated hydrogen gas. In a preferred embodiment there may be one dryer configured to follow the lead of one to up to a hundred electrolysers, or between one and fifty, or between one and twenty such devices. In some embodiments, one dyer may be operably controlled by between two and ten electrolysers, or between two and seven electrolysers. In an exemplary embodiment, one dryer may be operated by five electrolysers, but the number of lead devices can be selected, as set out above, based on physical and other considerations, such as demand, network capacity, physical space, etc.

Alternatively, the present invention may apply to one or more primary devices sharing one or more auxiliary devices. Each block of shared primary and auxiliary devices forming a single network within the microgrid. It is envisaged that there may be provided cross linking of networks within the microgrid. Physical communications for the transfer of a gas stream (e.g. hydrogen) for example may be provided. Alternatively, information alone may be shared for the purpose of monitoring and management the wider microgrid.

It is envisaged that regardless of a whole meshwork or partial meshwork, a master router may be determined by signal strength to ensure reliable communication. Diagnostic means may be provided to this effect, and the master router may change.

When the microgrid comprises a dryer control (mesh) network, comprising at least one electrolyser as a primary/leading device and at least one dryer as an auxiliary/following device, the dryer may be configured to start only when it is determined that at least one of the electrolysers is operating at a Steady state, this Steady state being indicative that the electrolyser(s) has (have) reached pre-determined conditions. The determination of whether the electrolyser is operating in the steady state is preferably based on data transmitted from the electrolyser through the network, the data preferably relating to the flowrate and/or pressure of a fluid in or output from the electrolyser (e.g. the flowrate and/or pressure of a gas stream, such as hydrogen, output from the electrolyser). In a preferred embodiment, this steady state may occur when one or more electrolysers are producing hydrogen at a certain flowrate and/or optimal pressure. The optimal pressure may be set to any reasonable pressure, preferably in the range of 1 bar to 100 bar, more preferably between 2 bar and 50 bar, and more preferably still within 10 bar and 30 bar, at substantially 20 bar. In some jurisdictions this is lower, so the dryer may be calibrated to work between 2 bar and 6 bar, at substantially 4 bar. In all other cases (i.e. not Steady state), the dryer may be automatically turned off. Alternatively, the dryer may be configured to turn on when any level of hydrogen is being generated by the electrolyser. An auxiliary component may also be adapted to turn off when the last connected primary device (e.g. electrolyser) turns off, or a pre-determined time after the final turn off.

An added benefit of allowing direct communication from the primary device (e.g. electrolyser) to the auxiliary device (e.g. dryer) is the ability to reduce the number of sensors required for the operation of the auxiliary device (e.g. dryer). This has a huge impact, not just on cost and complexity, but also in terms of the reduction in latency and the efficiency with which the devices can be switched on and, more importantly off when they are not required, which, in turn, has a significant environmental and ecological impact because devices are only running when absolutely necessary, and any delay in switching devices off when not required for use is minimised.

In one example where the microgrid comprises a primary device that is an electrolyser, and an auxiliary device that is a water tank for supplying water to the electrolyser and/or a water purification system for purifying the water supply, the water tank and/or water purification system can follow the electrolyser's water demand based on the operational status of the electrolyser. In this way, the water supply from the water tank and/or water purification system are activated only when it is determined, based on a parameter of the operation of the electrolyser, that a water supply or water purification is required. This ensures the freshness of the water supplied to the electrolyser, avoiding carbonation of the water.

In a preferred embodiment, the constituent components of the microgrid may have the requisite firmware for each component, and the associated application or other interface means. This includes the optional connection to a wireless communications network (e.g. the internet/cloud).

It should be noted that the microgrid (e.g. the dryer control (mesh) network) is based on wireless communication, therefore the functionality can be affected by the distance between devices, obstructions between the devices and other interference. Measures may need to be taken by the user to mitigate such potential interference, in appropriate circumstances.

The present invention allows set up and commissioning of a microgrid including lead devices (e.g. electrolysers), and following devices (e.g. dryers), without the need for an external controller or gateway. Configuration of the microgrid is fully automated or/with a Mobile App, or/with any computing equivalent and can be accomplished within minutes. Configuration of the microgrid operating in “island” (i.e. local) mode doesn't require any additional application and setup with control button or switch on the device front panel

Each leading device (e.g. electrolyser) is adapted to communicate their operating state, and/or measured sensor data to the auxiliary device (e.g. a selected dryer) directly, or via other devices in the meshwork, in real time. This rapid, live communication allows for better integration, and smoother operation of the dryer or other auxiliary/following devices. The term “following device” meaning that it is controlled (e.g. activated) in dependence on the operation of at least one of the one or more primary devices (e.g. when the electrolyser is activated and preferably reaches the pre-determined conditions, as discussed above).

Each leading device (e.g. electrolyser) connected to the microgrid in accordance with the present invention can provide sensor data, state data and alerts over a Modbus interface, allowing monitoring of the device. It is envisaged that the system is further adapted to allow for control of the auxiliary device(s) (e.g. dryers), including but not necessarily limited to: start, stop, restart, and alteration of the process setpoints. The process setpoints may include triggers for restart pressure, or conditions from the leading device (e.g. electrolyser) which would activate the following device (e.g. dryer). This may be applied to any kind of primary and auxiliary devices.

It is further envisaged that the microgrid may comprises one or more primary devices coupled in a mesh network in accordance with the present invention to more than one type of auxiliary device, and that an auxiliary device may also function as a primary device to another auxiliary device. For example a single mesh network may comprise an electrolyser, dryer, and compressor, wherein said electrolyser is a primary device for the auxiliary dryer, and the dryer and/or electrolyser being primary devices for said compressor.

In an alternative embodiment, where at least one electrolyser and at least one dryer are connected in the microgrid, it is envisaged that the dryer may function as a primary/leading device for managing the one or more auxiliary/following electrolysers. For example, a dryer requests the electrolysers to produce N litres of Hydrogen or to reduce production speed to ensure constant pressure on Dryer's output. Mesh devices can then make a quorum, or vary loading of each device, to determine which device should start taking into account:
1. Total number of working hours per device
2. Longest standby
3. Highest electrolyte temperature

Such a process aiding longer membrane lifetime, reduction of energy for side processes, and other process benefits.

### DETAILED DESCRIPTION

To help understanding of the invention, a specific embodiment thereof will now be described by way of example and with reference to the accompanying drawings, in which:

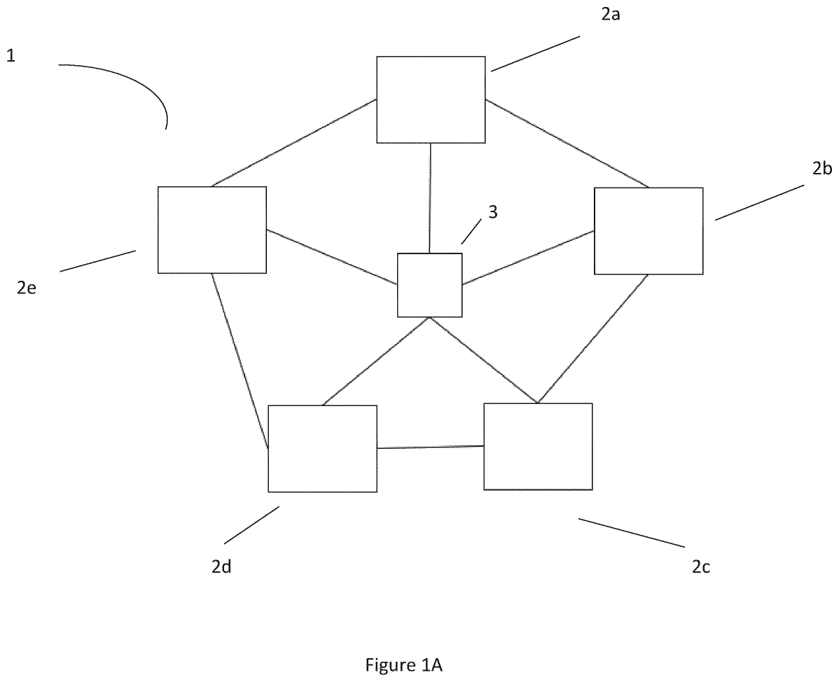

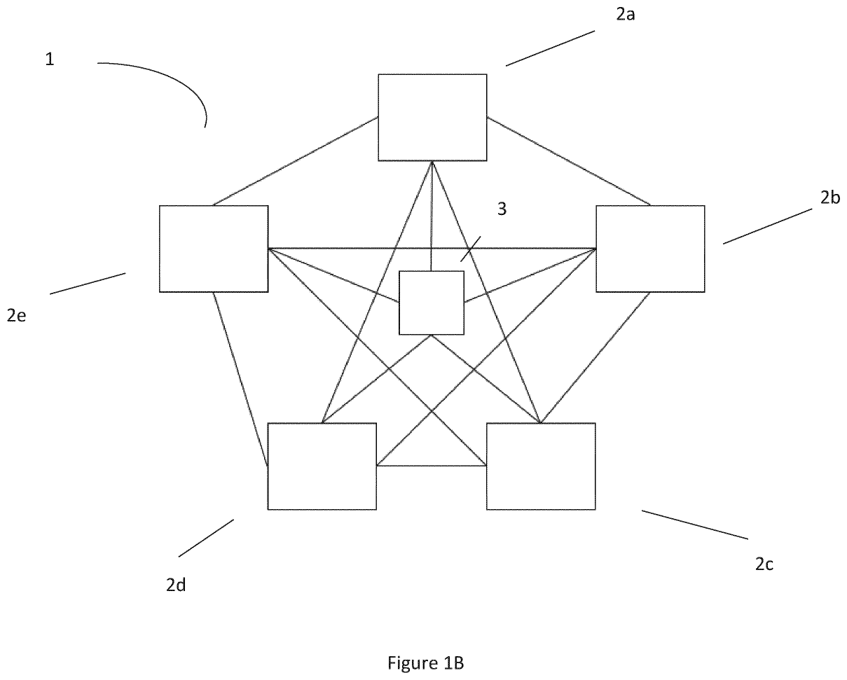

FIGS. 1A and 1B show microgrids comprising a partially connected mesh network and a full mesh network respectively;

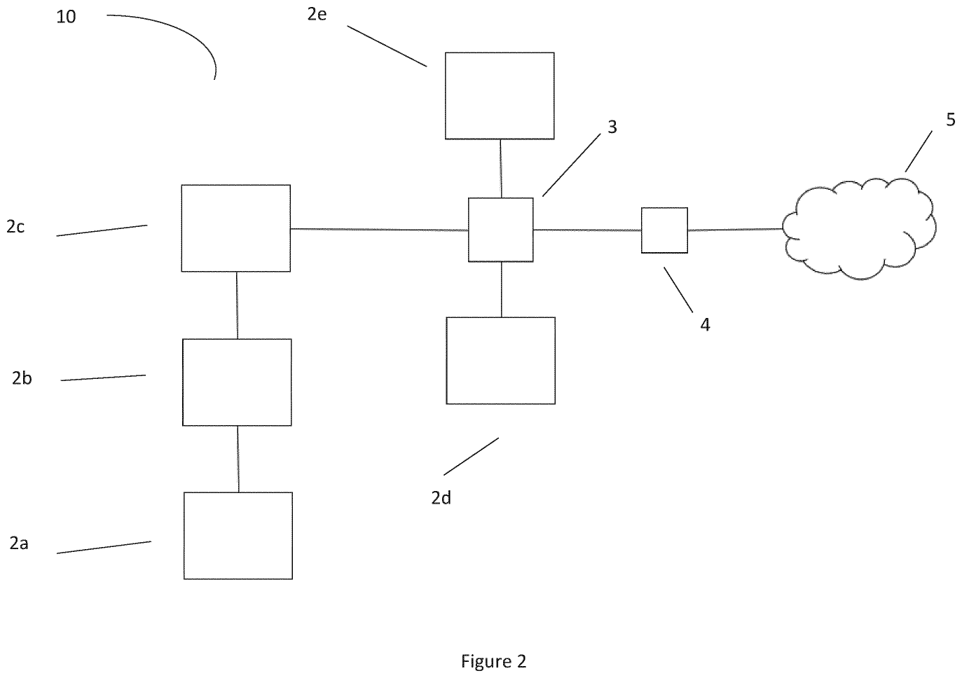

FIG. 2 is another embodiment of the microgrid comprising a partially connected mesh network with Internet connectivity; and

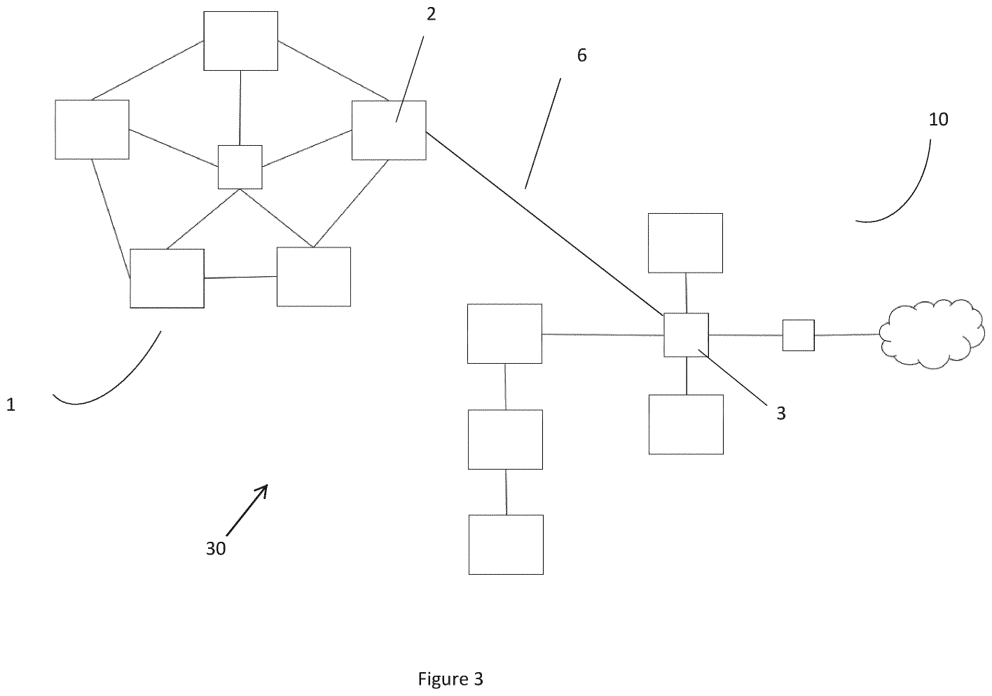

FIG. 3 is another embodiment of the microgrid comprising two mesh networks and showing communication between the two networks of primary and auxiliary devices.

Referring to FIG. 1a, a mesh networked microgrid can be seen. In this embodiment, the microgrid comprises multiple primary (i.e. leading) devices and a single auxiliary (i.e. following) device. The embodiment in FIG. 1a is that of a partially connected mesh network 1 meaning not all devices have direct links to all other devices. In the partially connected mesh network 1 of FIG. 1a, the primary devices are a plurality of electrolysers 2a-e, and the single auxiliary device is a single dryer 3. Whereas the wireless connections are shown by lines between the devices, the physical piped connections between each electrolyser 2a-e to the dryer 3 are not.

Partially connected mesh networks may exist because of interference within the network, or obstructions to signal, preventing a fully connected mesh network between the devices. Means are provided, but not shown, for the use of algorithms allowing devices to communicate via other devices. In the embodiment shown in FIG. 1A, dryer 3 acts as a central node allowing electrolyser 2a to communicate to electrolyser 2c via dryer 3 or electrolyser 2b respectively.

FIG. 1B shows a microgrid comprising a fully connected mesh network, similar to that in FIG. 1A. the difference being that each and every device maintains a communicable connection to each and every other device.

Now referring to FIG. 2, there is an embodiment more likely to be seen in real world applications for a microgrid. In the example of FIG. 2, the microgrid comprises a partially connected mesh network 10 comprising primary devices, which are a plurality of electrolysers 2a-e, and a single auxiliary device which is a single dryer 3. Electrolyser 2a is wirelessly connected to electrolyser 2b which itself is wirelessly connected to electrolyser 2c. Electrolyser 2c is wirelessly connected to dryer 3. Thus, these electrolysers form a chain such that electrolyser 2b is able to communicate to dryer 3 via the electrolyser 2c, and electrolyser 2a is able to communicate to dryer 3 via electrolysers 2b and 2c. Electrolysers 2d and 2e are independently communicatively connected to dryer 3. The dryer 3 is also operably connected to a router 4 which itself transmits information to the internet/cloud 5.

For each of FIGS. 1a, 1b and 2 the connection between the electrolysers and dryer are 2.4 GHz, with the dryer 3 to router 4 being IEEE 802.11 and onwards to the internet/cloud 5 for embodiments where such connection exists. Embodiments with no external internet connection operating in “island” (i.e. local) mode.

A key intention of the present invention is to allow the dryer 3 to be automatically activated upon receipt of a communication wirelessly transmitted that one or more of the electrolysers connected physically to it is turned on and thus producing hydrogen. Each of the five electrolysers 2a-e shown would have a piped physical connection for the transmission of hydrogen to the respective dryer.

Arrangements such as those in FIG. 2 may exist for a microgrid where there are multiple sites for electrolysers, or sources of energy. It is more sustainable to utilise a single dryer than having one at each location.

Referring to FIG. 3, there can be seen a microgrid 30 comprising the network 1 of FIG. 1A and the network 10 of FIG. 2 with a connection 6 between at least one electrolyser 2 of one network 1 and the dryer 3 if another network 10. Not shown are the potential physical connections to allow for the hydrogen produced by electrolysers in one network 1 to be treated by the dryer of the other network 10. Whilst only one of the networks is shown having a router and cloud connection, this is not necessarily the only case, but allows for more remote networks or devices within the microgrid to obtain internet connectivity over longer distances.

The invention is not intended to be restricted to the details of the above-described embodiment. For instance, other electrochemical devices may be used, or other following devices such as compressors, fuel cells and more.

Additionally, any measured information may be communicated between devices to trigger pre-determined actions.

Whilst the figures focus on the preferred example of primary electrolysers and auxiliary dryers, the present invention is not necessarily intended to be limited to such a configuration; and it will be apparent to a person skilled in the art, from the foregoing description, that modifications and variations can be made to the described embodiments without departing from the scope of the invention as defined by the appended claims.

Further aspects of the present disclosure are set out in the following numbered clauses:

1. A microgrid comprising:
a plurality of devices including at least:
one or more primary devices, wherein said primary devices are leading devices, and one or more auxiliary devices, wherein said auxiliary devices are following devices,
means associated with each primary and auxiliary device for wireless transmission and reception of data;
wherein:
the plurality of devices is configured to form at least a partially connected mesh network, and
an active state of the one or more auxiliary devices is dependent on a communicated active state of the one or more primary devices.

2. A microgrid according to clause 1, wherein the primary device is an electrolyser, and the auxiliary device is a dryer.

3. A microgrid according to clause 1 or 2, wherein the auxiliary device is adapted to activate when any one or more of the primary devices activates.

4. A microgrid according to any preceding clause wherein, the at least partially connected mesh network is a complete mesh network.

5. A microgrid according to any preceding clause wherein the mesh network is further connected to a database for the recording of transmitted data.

6. A microgrid according to any preceding clause wherein the data is any one or more of:
Pressure
Temperature,
Flowrate,
On/off status,
voltage,
amperage,
energy demand,
water level,
water conductivity,
errors, and
cumulative run time of device.

7. A microgrid according to any preceding clause wherein the mesh network is connected to the internet.

8. A microgrid according to any preceding clause wherein shortest path bridging is used for communication between the primary and auxiliary devices.

9. A microgrid according to any preceding clause wherein the one or more primary devices is an AEM electrolyser.

10. A microgrid according to clause 9 wherein the AEM electrolyser has a dry cathode.

11. A microgrid according to any preceding clause wherein one or more of the primary and auxiliary devices is connected to a central computing/control means.

12. A microgrid according to any preceding clause wherein each device comprises a communication module.

13. A microgrid according to any preceding clause wherein the primary and auxiliary devices communicate via any one or more of
Bluetooth®
Wi-Fi, and
radio

14. A microgrid according to any preceding clause wherein a user can remotely monitor communicated information from a separate computing device.

15. A microgrid according to any preceding clause wherein each device has a unique identifier code.

It will be understood that the present invention has been described above purely by way of example, and modifications of detail can be made within the scope of the invention.

1. A microgrid comprising:
a plurality of devices including at least:
one or more primary devices, and
one or more auxiliary devices,
the plurality of devices being configured to form an at least partially connected mesh network for wireless communication of information between the devices, wherein
at least one of the one or more auxiliary devices is controlled in dependence on communicated information relating to the operation of at least one of the one or more primary devices.

2. A microgrid as claimed in claim 1, wherein the primary device is an electrochemical device, preferably wherein the electrochemical device is an electrolyser, more preferably an AEM electrolyser, yet more preferably an AEM electrolyser with a dry cathode.

3.-5. (canceled)

6. A microgrid as claimed in claim 1, wherein the one or more auxiliary devices are balance of plant devices for the primary device, preferably wherein one auxiliary device provides a balance of plant device for multiple primary devices, and wherein each of the one or more primary devices are physically connected to at least one of the one or more auxiliary devices, preferably wherein one auxiliary device is physically connected to multiple primary devices, more preferably wherein the physical connection facilitates a transfer of fluid or electricity between the devices.

7. (canceled)

8. A microgrid as claimed in claim 6, wherein the balance of plant device is at least one of:
a water tank for supplying water to the primary device via the physical connection;
a dryer for drying a gas stream, preferably a hydrogen gas steam, received from the primary device via the physical connection; and/or
a compressor for compressing a gas stream, preferably a hydrogen gas steam, received from the primary device via the physical connection.

9. A microgrid as claimed in claim 1, wherein the control of the auxiliary device comprises: activating, deactivating, or restarting the auxiliary device in dependence on the communicated information relating to the operation of at least one of the one or more primary devices.

10. A microgrid as claimed in claim 1, wherein the control of the auxiliary device comprises setting a process setpoint for a process carried out by the auxiliary device and/or controlling a power level of the auxiliary device in dependence on the communicated information relating to the operation of at least one of the one or more primary devices.

11. A microgrid as claimed in claim 1, wherein the information relating to the operation of at least one of the one or more primary devices comprises a measurement of a parameter of a process carried out by the primary device, preferably wherein the measurement is taken by a sensor of the primary device.

12. A microgrid as claimed in claim 1, wherein the information relating to the operation of at least one of the one or more primary devices comprises:
a pressure, preferably relating to the pressure of fluid output from the primary device;
a temperature, preferably relating to the temperature of an electrolyte when the primary device is an electrolyser;
a flowrate, preferably relating to the pressure of fluid input to or output from the primary device;
an active status indicative of whether the primary device is active or inactive;
a voltage,
an amperage,
an energy demand of the primary device,
a water level,
a water conductivity,
errors, and
a cumulative run time or cumulative inactive time of the primary device.

13. A microgrid as claimed in claim 1, comprising one or more tertiary devices, wherein at least one of the one or more tertiary devices is controlled in dependence on communicated information relating to the operation of at least one of the one or more auxiliary devices.

14. A microgrid as claimed in claim 1, wherein the at least partially connected mesh network is a fully connected mesh network.

15. A microgrid as claimed in claim 1, wherein the mesh network is:
further connected to a database for the recording of the communicated information; and/or connected to the internet.

16. (canceled)

17. A microgrid as claimed in claim 1, wherein shortest path bridging is used for communication between the primary and auxiliary devices.

18. A microgrid as claimed in claim 1, wherein one or more of the primary and auxiliary devices is connected to a central computing/control means.

19. A microgrid as claimed in claim 1, wherein each device comprises a communication module for communicating information between the devices, preferably wherein the primary and auxiliary devices communicate via any one or more of
Bluetooth®
Wi-Fi, and
Radio.

20. (canceled)

21. A microgrid as claimed in claim 1, wherein a user can remotely monitor communicated information from a separate computing device.

22. A microgrid as claimed in claim 1, wherein each device has a unique identifier code.

23. An electrochemical device or balance of plant device comprising:
means for connecting to an at least partially connected mesh network comprising at least one other device; and
wireless communication means, the wireless communication means configured to wirelessly transmit or receive information to or from the at least one other device, said information relating to the operation of the device or the at least one other device in the network.

24. A device as claimed in claim 23, comprising a controller configured to control the device in dependence on received information relating to the operation of the at least one other device in the network.

25. A device as claimed in claim 23, wherein the device is one or more of: an electrolyser, preferably an AEM electrolyser, more preferably an AEM electrolyser with a dry cathode; a renewable power source; a dryer; a water tank; and a compressor.

26. A method for controlling devices in a microgrid, the microgrid comprising a plurality of devices including at least: one or more primary devices and one or more auxiliary devices, the method comprising:
connecting the plurality of devices to form an at least partially connected mesh network for wireless communication of information between the devices, and
controlling at least one of the one or more auxiliary devices in dependence on communicated information relating to the operation of at least one of the one or more primary devices.
